(19) United States
(12) Patent Application Publication
(10) Pub. No.: US 2026/0245987 A1
(43) Pub. Date: Aug. 20, 2026

(54) SECONDARY BATTERY AND METHOD OF MANUFACTURING THE SECONDARY BATTERY

(71) Applicant: SAMSUNG SDI CO., LTD., Yongin-si (KR)

(72) Inventors: Kwangjo CHEONG, Yongin-si (KR); Jeawoan LEE, Yongin-si (KR); Won-Seok KIM, Yongin-si (KR); Soo-Mi EO, Yongin-si (KR)

(21) Appl. No.: 19/541,583

(22) Filed: Feb. 17, 2026

(30) Foreign Application Priority Data
Feb. 18, 2025 (KR) 10-2025-0021090

(51) Int. Cl. H01M 10/42; C08F 220/36; C08F 222/22; H01M 10/0565; H01M 10/0566; H01M 10/44; H01M 50/14; H01M 50/586; H01M 50/59; H01M 50/636

(52) U.S. Cl. CPC H01M 10/4235; C08F 220/36; C08F 222/22; H01M 10/0565; H01M 10/0566; H01M 10/44; H01M 50/14; H01M 50/586; H01M 50/59; H01M 50/636; H01M 2300/0025; H01M 2300/0082; H01M 2300/0085

(57) ABSTRACT

A method of manufacturing a secondary battery includes preparing a case in which an electrode assembly is accommodated. A first electrolyte is injected into an interior of the case through an electrolyte injection hole formed in the case. A solution is injected into the interior of the case after the first electrolyte has been injected through the electrolyte injection hole of the case. The solution includes a second electrolyte, a monomer, and a polymerization initiator.

### CROSS-REFERENCE TO RELATED APPLICATION

The present application claims priority to and the benefit of Korean Patent Application No. 10-2025-0021090, filed on Feb. 18, 2025, in the Korean Intellectual Property Office, the entire disclosure of which is incorporated by reference herein.

### BACKGROUND

### Field

The present disclosure relates to secondary batteries and methods for manufacturing the secondary batteries.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When the secondary battery is damaged by a physical impact such as when dropped, a short circuit may occur inside the secondary battery. A short circuit inside the secondary battery may sharply decrease internal electrical resistance so that an excessive current may flow. As a result, thermal runaway may occur, which causes the internal temperature of the battery to rise rapidly. Similarly, when the secondary battery is exposed to a high-temperature environment, thermal runaway may occur inside the secondary battery, which may lead to an explosion or a fire of the secondary battery. Therefore, it may be important to protect the secondary battery from external impacts while not affecting the energy density of the secondary battery.

The above information disclosed in this Background section is for enhancement of understanding of the background of the present disclosure, and therefore, it may contain information that does not constitute related (or prior) art.

### SUMMARY

The present disclosure provides a secondary battery and a method for manufacturing the secondary battery to solve the above-described technical problems.

These and other aspects and features of the present disclosure will be described in or will be apparent from the following description of embodiments of the present disclosure.

In some embodiments, a method of manufacturing a secondary battery includes preparing a case which an electrode assembly is accommodated, injecting a first electrolyte into an interior formed in the case through an electrolyte injection hole of the case, and injecting a solution into the interior of the case, after the first electrolyte has been injected, through the electrolyte injection hole of the case, wherein the solution includes a second electrolyte, a monomer, and a polymerization initiator.

In some embodiments, the method of manufacturing a secondary battery may further include, after injecting the first electrolyte, performing an aging process by allowing a predetermined time to elapse with the first electrolyte injected in the case.

Additionally, the method of manufacturing a secondary battery may further include, after performing the aging process, performing charging and discharging through electrode terminals formed in the case.

Additionally, the method of manufacturing a secondary battery may further include sealing the electrolyte injection hole of the case after the first electrolyte and the solution have been injected.

Additionally, the method of manufacturing a secondary battery may further include, after injecting the solution, exposing the case to a predetermined temperature so that the monomer and the polymerization initiator react with each other to form a gel polymer.

Additionally, the predetermined temperature may be 40° C. to 80° C.

Additionally, the gel polymer may include at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile).

Additionally, an amount of the first electrolyte may be 40% to 70% based on 100% of a total volume or weight of the first electrolyte and the second electrolyte.

Additionally, an amount of the monomer may be 2 wt % to 15 wt % based on 100 wt % of a total weight of the first electrolyte and the second electrolyte.

Additionally, an amount of the polymerization initiator may be 150 ppm to 450 ppm based on 100 wt % of a total weight of the first electrolyte and the second electrolyte.

Additionally, the monomer may include a functional monomer including at least one of urethane acrylate, hexyl acrylate, acrylate, acrylic acid, methacrylic acid, and a mixture including the acrylic acid and the methacrylic acid.

Additionally, the polymerization initiator may include at least one of a peroxide-based compound and an azo-based compound.

In some embodiments, a secondary battery includes an electrode assembly, an electrolyte at least partially impregnated in the electrode assembly, a mixture of a monomer and a polymerization initiator, and a case accommodating the electrode assembly, the electrolyte, and the mixture of the monomer and the polymerization initiator.

Additionally, an amount of the monomer may be 2 wt % to 15 wt % based on 100 wt % of a total weight of the electrolyte.

Additionally, the monomer may include a functional monomer including at least one of urethane acrylate, hexyl acrylate, acrylate, acrylic acid, methacrylic acid, and a mixture including the acrylic acid and the methacrylic acid.

Additionally, an amount of the polymerization initiator may be 150 ppm to 450 ppm based on 100 wt % of a total weight of the electrolyte.

Additionally, the polymerization initiator may include at least one of a peroxide-based compound and an azo-based compound.

Additionally, a secondary battery includes an electrode assembly, an electrolyte at least partially impregnated in the electrode assembly, a gel polymer, and a case accommodating the electrode assembly, the electrolyte, and the gel polymer, wherein at least a portion of the gel polymer is disposed in a void between the electrode assembly and the case.

Additionally, an amount of the gel polymer located outside the electrode assembly inside the case may be greater than an amount of the gel polymer located inside the electrode assembly.

Additionally, a structure of the gel polymer may include at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile).

According to some embodiments of the present disclosure, the gel polymer disposed between the electrode assembly and the case inside the case may improve safety characteristics such as resistance to impacts, heat exposure, and short circuits.

According to some embodiments of the present disclosure, since the gel polymer is relatively more located outside the electrode assembly rather than inside the electrode assembly inside the case, at least one of the electrode assembly and the case may be protected. Additionally, since the gel polymer is located inside the electrode assembly in a small proportion, movement of ions through the electrolyte may not be hindered. Accordingly, while stability of the secondary battery is improved, performance of the secondary battery may be maintained.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view illustrating an example of a secondary battery according to an embodiment of the present disclosure.

FIG. 2 illustrates an example of a secondary battery according to an embodiment of the present disclosure.

FIG. 3 is a flowchart of a method of manufacturing a secondary battery according to an embodiment of the present disclosure.

FIG. 4 is a flowchart of a method of manufacturing a secondary battery according to an embodiment of the present disclosure.

FIG. 5 is a flowchart of a method of manufacturing a secondary battery according to an embodiment of the present disclosure.

FIGS. 6 to 10 are diagrams for explaining a method of manufacturing a secondary battery according to an embodiment of the present disclosure.

FIG. 11 is a cross-sectional view of a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of layers and regions shown in the drawings may be exaggerated for clarity of explanation. That is, the sizes shown in the drawings are only for convenience of understanding and are not limited thereto. Also, the same reference numerals throughout the specification refer to the same constituent elements.

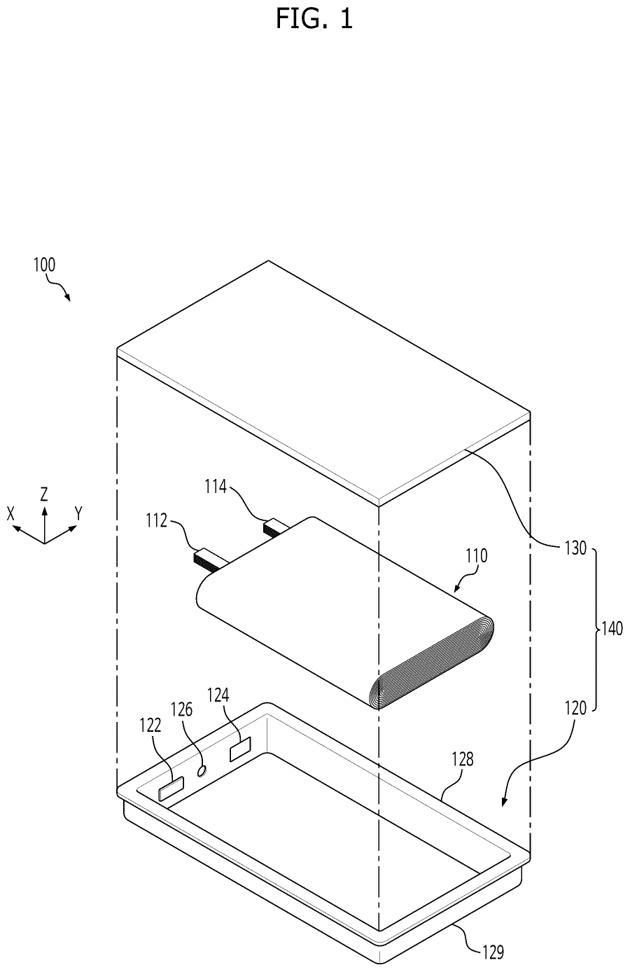

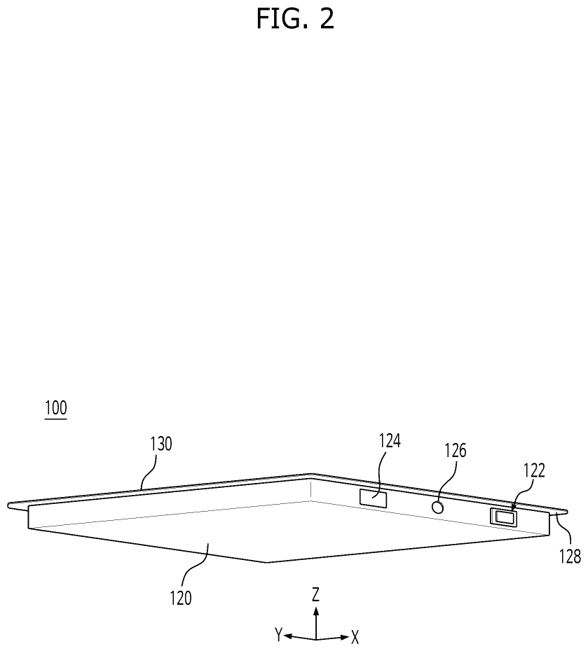

FIG. 1 is an exploded perspective view illustrating an example of a secondary battery 100 according to an embodiment of the present disclosure. FIG. 2 illustrates an example of the secondary battery 100 according to an embodiment of the present disclosure.

Referring to FIGS. 1 and 2, the secondary battery 100 may include an electrode assembly 110 including a positive electrode, a separator, and a negative electrode, and a case 140 accommodating the electrode assembly 110. The case 140 may include a case body 120 that accommodates the electrode assembly 110 and has one surface (e.g., one surface in the Z-direction of the case body 120) forming an opening. A cover 130 may close the opening in the surface of the case body 120 and coupled to the case body 120. The electrode assembly 110 may be wound or stacked with the separator, which is an insulator, interposed between the positive electrode and the negative electrode.

The case 140 may include stainless steel (SUS), and the secondary battery 100 may be a SUS can-type secondary battery. The case 140 of a SUS can-type secondary battery can have a thickness of about 0.1 mm, and sufficient stability may be secured due to the characteristics of SUS. However, the present disclosure is not limited thereto. For example, the case 140 may be formed of a conductive metal such as aluminum, an aluminum alloy, or nickel-plated steel, forming the overall exterior of the secondary battery 100.

A first electrode tab 112 may be connected to a first side of a first electrode (e.g., the positive electrode) of the electrode assembly 110, and a second electrode tab 114 may be connected to a second side of a second electrode (e.g., the negative electrode). The first electrode tab 112 and the second electrode tab 114 may be connected by welding a collector tab to non-coated regions of the first electrode and the second electrode, or by punching the non-coated regions of the first electrode and the second electrode. In a wound state, the first electrode tab 112 and the second electrode tab 114 may be arranged side by side at regular intervals or may be disposed on different sides of the electrode assembly 110. That is, the electrode assembly 110 may have an arbitrary structure including electrode tabs. The first electrode tab 112 may be a positive electrode tab, and the second electrode tab 114 may be a negative electrode tab. But the present disclosure is not limited to such a configuration, and the first electrode tab 112 may be a negative electrode tab while the second electrode tab 114 is a positive electrode tab.

The case 140 may include a first electrode terminal 122 and a second electrode terminal 124. The first electrode terminal 122 may be electrically connected to the first electrode tab 112 of the electrode assembly 110, and the second electrode terminal 124 may be electrically connected to the second electrode tab 114 of the electrode assembly 110. The first electrode terminal 122 and the second electrode terminal 124 may be formed on another surface (e.g., a surface in the X-direction) of the case body 120. Positions of the first electrode terminal 122 and the second electrode terminal 124 are not limited to those depicted in FIG. 1 and may be variously modified.

In an embodiment, the case body 120 may include an electrolyte injection hole 126. The electrolyte injection hole 126 may be a through-hole formed in one surface (e.g., a surface in the X-direction) of the case body 120. After the case body 120 and the cover 130 are joined to seal the case body 120, the electrolyte injection hole 126 may be formed such that an electrolyte can be into an interior of the secondary battery 100 through the electrolyte injection hole 126. Although the electrolyte injection hole 126 is shown located between the first electrode terminal 122 and the second electrode terminal 124, it is not limited thereto and may be variously modified.

In an embodiment, the case body 120 may include a receiving portion 129 and a flange 128. Specifically, the receiving portion 129, which receives the electrode assembly 110, may be formed at a substantially central region of the case body 120 by appropriately using a press-working process or the like. In addition, the flange 128 may extend outward from an upper end of the receiving portion 129. For example, the flange 128 may be formed in four directions at an upper edge of the receiving portion 129.

The case body 120 and the cover 130 may be joined to form an exterior of the secondary battery 100. For example, the case body 120 and the cover 130 may be joined by metal joining (e.g., welding, brazing, or soldering). In such a configuration, edges of the flange 128 of the case body 120 and the cover 130 may be joined. After the case body 120 and the cover 130 are joined, at least a portion of the flange 128 may be cut by a laser to increase an energy density of the secondary battery 100.

In FIG. 1, the case body 120 is shown to include the flange 128, but the present disclosure is not limited thereto. For example, the case body 120 may not include the flange 128. The cover 130 may be coupled to a side of the receiving portion 129 and form the exterior of the secondary battery 100 together with the case body 120.

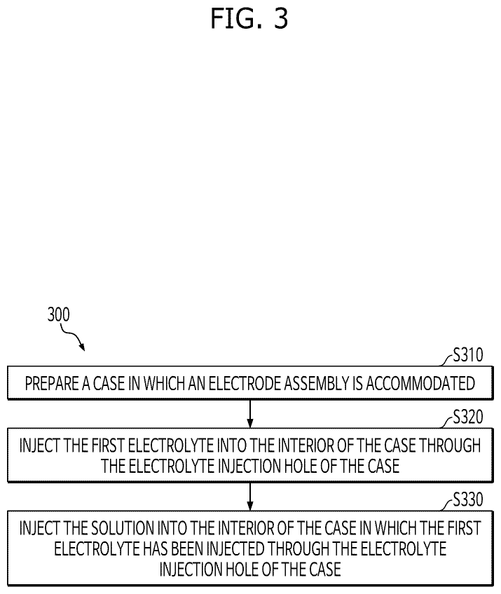

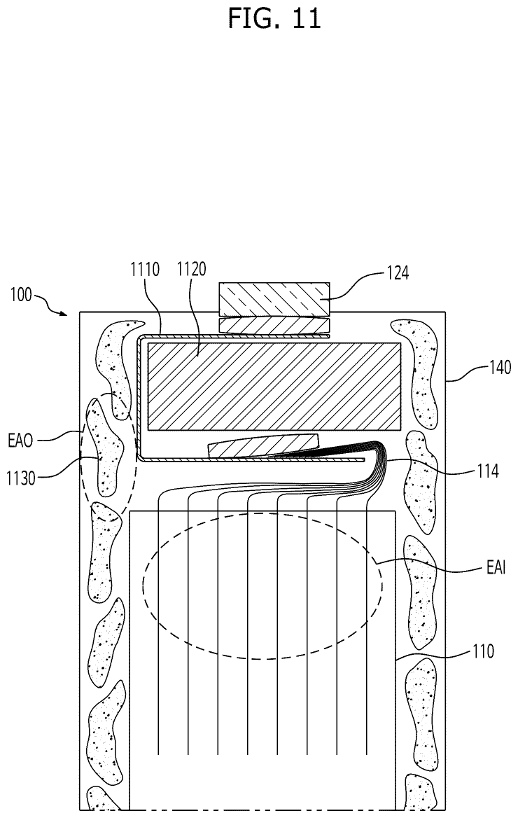

In an embodiment, an electrolyte, a monomer, and a polymerization initiator may be injected into the interior of the case 140 through the electrolyte injection hole 126. For example, the first electrolyte may be injected into the interior of the case 140 through the electrolyte injection hole 126. Thereafter, a solution including the second electrolyte, the monomer, and the polymerization initiator may be injected into the interior of the case 140 through the electrolyte injection hole 126. The secondary battery 100 may undergo a predetermined process (e.g., aging, charging and discharging, and a thermochemical reaction), and a gel polymer may then be formed inside the case 140. A process of forming the gel polymer will be described in detail below with reference to FIGS. 3 to 10. The positions and structures of the gel polymer will be described in detail below with reference to FIG. 11.

The secondary battery 100 may be a lithium battery cell or a sodium battery cell. However, the scope of the present disclosure is not limited to such examples, and the secondary battery 100 may include all batteries capable of repeatedly supplying electric power through charging and discharging. In an embodiment, when the secondary battery 100 is a lithium battery cell, the secondary battery 100 may be used in an electric vehicle (EV) because of excellent life characteristics and high-rate characteristics of the secondary battery 100. In another example, the secondary battery 100 may be used in a hybrid vehicle such as a plug-in hybrid electric vehicle (PHEV). In addition, the lithium battery cell may be used in fields requiring power storage in various ranges such as smart phones, tablet computers, electric bicycles, and electric power tools.

FIG. 3 is a flowchart 300 of a method of manufacturing a secondary battery according to an embodiment of the present disclosure. In an embodiment, the method of manufacturing a secondary battery may be performed by a secondary battery manufacturing apparatus.

First, the secondary battery manufacturing apparatus may prepare a case in which an electrode assembly is accommodated (S310). For example, the electrode assembly (e.g., the electrode assembly 110 of FIG. 1) may be accommodated in the receiving portion (e.g., the receiving portion 129 of the case body 120 of FIG. 1). Subsequently, the cover (e.g., the cover 130 of FIG. 1) may be seated on the opened surface of the case body, and the cover and the case body may be joined. As a result, except for a region such as the electrolyte injection hole (e.g., the electrolyte injection hole 126 of FIG. 1) of the case, the case may be sealed with the electrode assembly in the case.

The secondary battery manufacturing apparatus may inject the first electrolyte into the interior of the case through the electrolyte injection hole of the case (S320). The secondary battery manufacturing apparatus also may inject the solution into the interior of the case after the first electrolyte has been injected through the electrolyte injection hole of the case (S330). The solution may include the second electrolyte, the monomer, and the polymerization initiator. The first electrolyte and the second electrolyte may be electrolytes having the same components and/or composition. An amount of the first electrolyte may be 40% to 70% based on 100% of a total volume or weight of the first electrolyte and the second electrolyte, and an amount of the second electrolyte may be 30% to 60% based on 100% of the total volume or weight of the first electrolyte and the second electrolyte.

In an embodiment, degassing may be performed on the case before the solution is injected into the case. By removing gases inside the case, a space for accommodating the solution inside the case may be secured.

The electrolyte solution for a rechargeable lithium battery may include a non-aqueous organic solvent and a lithium salt.

The non-aqueous organic solvent may serve as a medium for transferring ions participating in an electrochemical reaction of the battery.

The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, valerolactone, caprolactone, and the like.

The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (wherein R is a C2 to C20 linear, branched, or cyclic hydrocarbon group, a double bond, an aromatic ring, or an ether bond, and the like; amides such as dimethylformamide; dioxolanes such as 1,3-dioxolane, 1,4-dioxolane, and the like; sulfolanes, and the like.

The non-aqueous organic solvents may be used alone or in combination of two or more.

In addition, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

In an embodiment, the monomer may include a functional monomer including at least one of urethane acrylate, hexyl acrylate, acrylate, acrylic acid, methacrylic acid, and a mixture including the acrylic acid and the methacrylic acid. An amount of the monomer may be 2 wt % to 15 wt % based on 100 wt % of a total weight of the first electrolyte and the second electrolyte.

In an embodiment, the polymerization initiator may include at least one of a peroxide-based compound and an azo-based compound. An amount of the polymerization initiator may be 150 ppm to 450 ppm based on 100 wt % of a total weight of the first electrolyte and the second electrolyte.

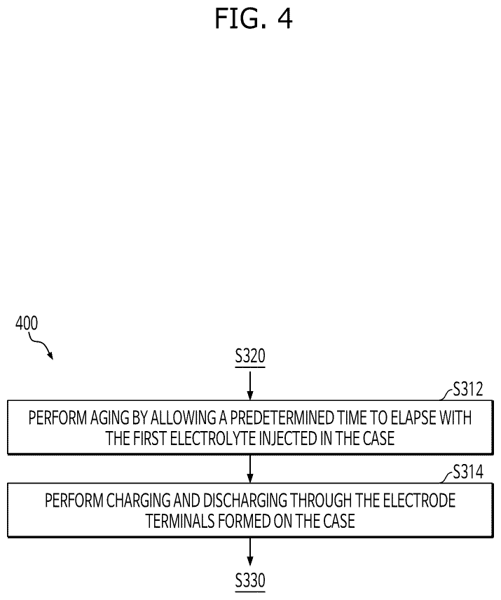

FIG. 4 is a flowchart 400 of a method of manufacturing a secondary battery according to an embodiment of the present disclosure.

In an embodiment, after executing step S320 of FIG. 3, the secondary battery manufacturing apparatus may further perform an aging process by allowing a predetermined time to elapse with the first electrolyte injected in the case (S312). By performing the aging process, at least a portion of the first electrolyte may permeate into the electrode assembly so that at least a portion of the first electrolyte is impregnated in the electrode assembly.

In an embodiment, the secondary battery manufacturing apparatus may perform charging and discharging through the electrode terminals formed on the case (S314). By performing charging and discharging after the first electrolyte is impregnated in the electrode assembly, a solid electrolyte interphase (SEI) may be formed on a surface of an electrode (e.g., the negative electrode) of the electrode assembly. As a result, the electrode of the electrode assembly may be activated to enable charging and discharging. Thereafter, step S330 of FIG. 3 may be performed.

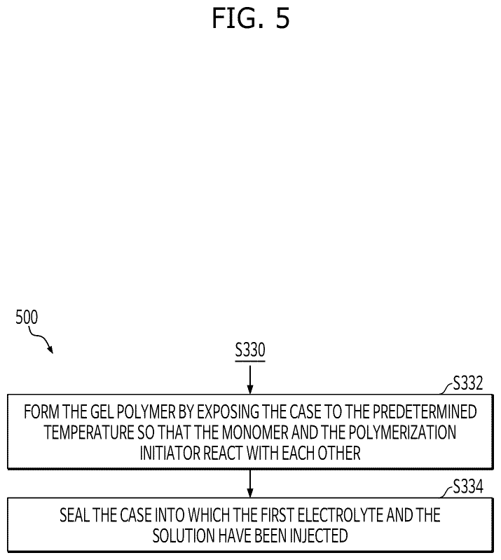

FIG. 5 is a flowchart 500 of a method of manufacturing a secondary battery according to an embodiment of the present disclosure.

In an embodiment, after executing step S330 of FIG. 3, the secondary battery manufacturing apparatus may form the gel polymer by exposing the case to the predetermined temperature so that the monomer and the polymerization initiator react with each other (S332). For example, the secondary battery may be exposed to 40° C. to 80° C. for about 1 to 3 hours. Thereafter, the secondary battery manufacturing apparatus may seal the case into which the first electrolyte and the solution have been injected (S334). For example, the secondary battery manufacturing apparatus may seal the electrolyte injection hole of the case.

In an embodiment, the gel polymer may include at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile).

At least a portion of the gel polymer may be disposed in the void between the electrode assembly and the case rather than inside the electrode assembly. The gel polymer disposed between the electrode assembly and the case may improve safety characteristics of the secondary battery, such as resistance to impacts, heat exposure, and short circuits.

The flowcharts of FIGS. 3 to 5 and the above descriptions are only examples, and the scope of the present disclosure is not limited to the flowcharts of FIGS. 3 to 5 and the above descriptions. For example, one or more steps of the flowcharts and the above descriptions may be added, changed, or deleted; an order of one or more steps may be changed; and one or more steps may be performed simultaneously.

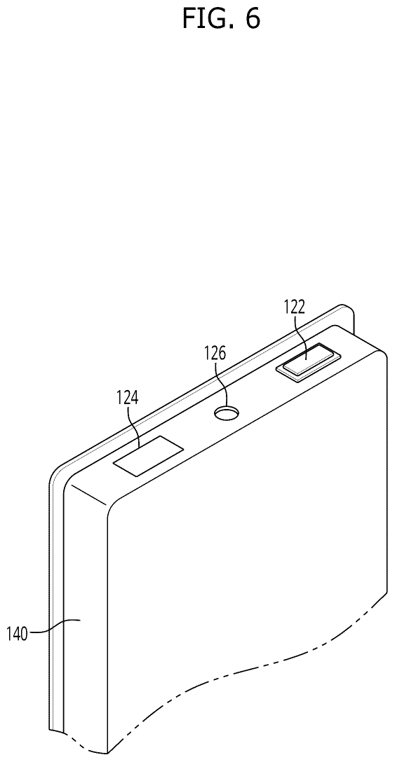

FIGS. 6 to 10 are diagrams for explaining a method of manufacturing a secondary battery according to an embodiment of the present disclosure.

Referring to FIG. 6, the case 140 accommodating the electrode assembly may be prepared. The case 140 may include the first electrode terminal 122 and the second electrode terminal 124 formed on one surface. An electrolyte injection hole 126 may also be formed on one surface of the case 140. The first electrode terminal 122 and the second electrode terminal 124 may be connected to external terminals. The electrolyte injection hole 126 may be configured so that an electrolyte, solution, etc. can be injected.

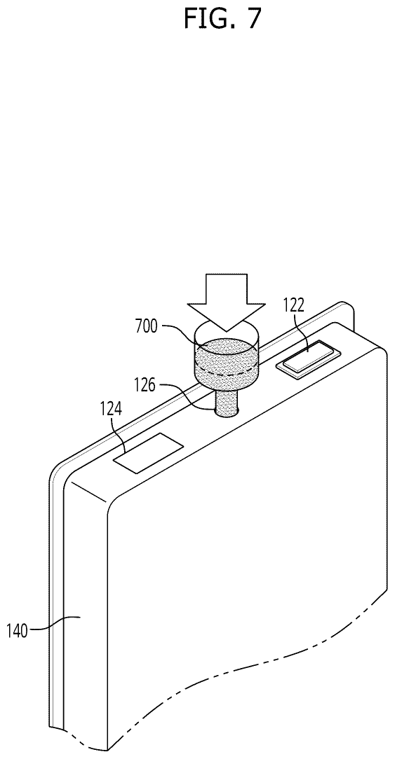

Referring to FIG. 7, the first electrolyte 700 may be injected into the interior of the case 140 through the electrolyte injection hole 126 of the case 140. Thereafter, an aging process may be performed on the case 140 in which the first electrolyte 700 has been injected. As a result, at least a portion of the first electrolyte 700 may be impregnated in the electrode assembly accommodated in the case 140.

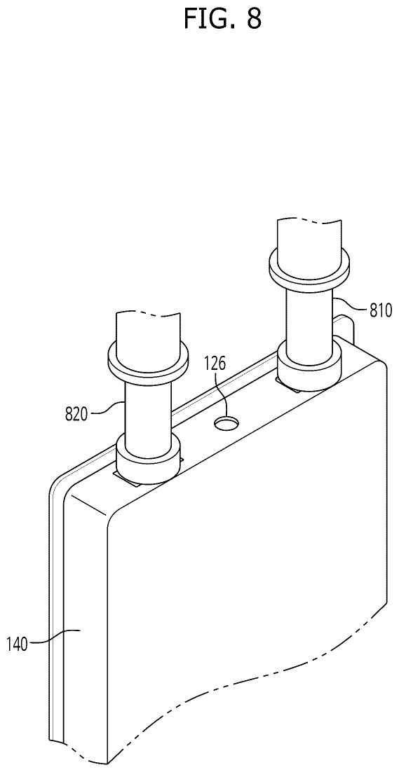

Referring to FIG. 8, the first electrode terminal 122 of the case 140 may be electrically connected to a first external terminal 810 of a charging apparatus. The second electrode terminal 124 of the case 140 may be electrically connected to a second external terminal 820 of the charging apparatus. For example, the first external terminal 810 may be an external terminal corresponding to the positive electrode, and the second external terminal 820 may be an external terminal corresponding to the negative electrode but are not limited thereto and may be vice versa.

In an embodiment, electric power may be applied between the first electrode terminal 122 and the second electrode terminal 124 through the first external terminal of the charging apparatus and the second external terminal. Thus, charging of the configuration (e.g., the electrode assembly) inside the case 140 may be performed. When charging is performed, the SEI may be formed on a surface of the electrode of the electrode assembly.

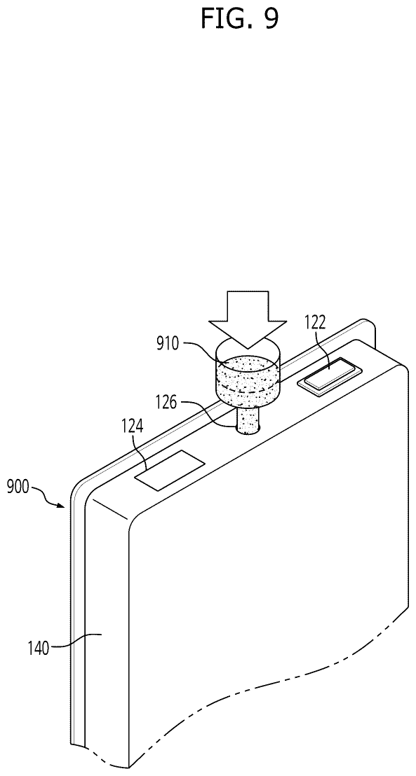

Referring to FIG. 9, the solution 910 may be injected through the electrolyte injection hole 126 of the case 140. The solution 910 may include the second electrolyte, the monomer, and the polymerization initiator. The second electrolyte may function as a solvent for the monomer and the polymerization initiator.

Degassing may be performed on the case 140 before the solution 910 is injected into the case 140. For example, gas inside the case 140 may be discharged through the electrolyte injection hole 126.

The monomer may include a functional monomer including at least one of urethane acrylate, hexyl acrylate, acrylate, acrylic acid, methacrylic acid, and a mixture including the acrylic acid and the methacrylic acid. An amount of the monomer may be 2 wt % to 15 wt % based on 100 wt % of a total weight of the first electrolyte and the second electrolyte.

The polymerization initiator may include at least one of a peroxide-based compound and an azo-based compound. An amount of the polymerization initiator may be 150 ppm to 450 ppm based on 100 wt % of a total weight of the first electrolyte and the second electrolyte.

The secondary battery 900 may include an electrode assembly, an electrolyte at least partially impregnating the electrode assembly, and a case accommodating the electrode assembly and the electrolyte. The electrolyte may be a combination of the first electrolyte and the second electrolyte. Additionally, the secondary battery 900 may further include a mixture of the monomer and the polymerization initiator, and the mixture may be accommodated in the case.

The secondary battery 900 may be exposed to an atmosphere set to the predetermined temperature for the predetermined time. For example, the secondary battery 900 may be placed in a heating chamber configured to form the atmosphere set to the predetermined temperature. The predetermined temperature may be higher than room temperature. For example, the predetermined temperature may be 40° C. to 80° C. The predetermined time may be about 1 to 3 hours. The monomer and the polymerization initiator present inside the secondary battery 900 may react with each other to form the gel polymer. At least a portion of the gel polymer may be disposed in the void between the electrode assembly and the case 140.

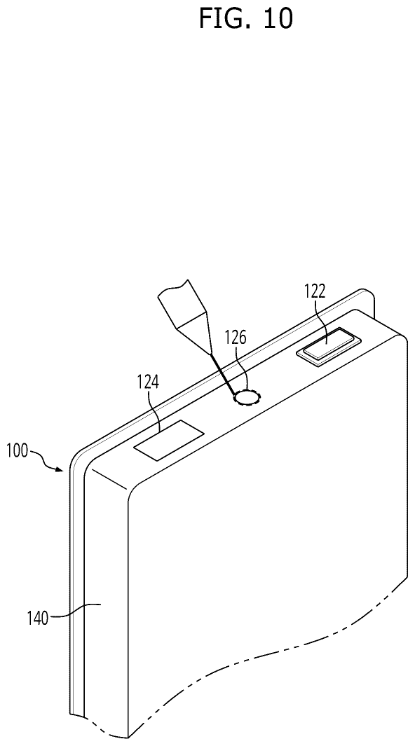

Referring to FIG. 10, the case 140 into which the solution has been injected may be sealed. In particular, the electrolyte injection hole 126 of the case 140 may be sealed. For example, a sealing member may cover the electrolyte injection hole 126, and the electrolyte injection hole 126 may be sealed by welding the sealing member to the case 140. In another example, the sealing member may be attached to the case 140 with an adhesive while being positioned on the electrolyte injection hole 126. But the method of sealing the electrolyte injection hole 126 is not limited thereto and may be variously modified.

Through the above-described method, the secondary battery 100 manufactured may include the gel polymer inside the case 140, and at least a portion of the gel polymer may be disposed in the void between the electrode assembly and the case 140.

In a test example according to the various embodiments described above, it was confirmed that the gel polymer was formed inside the case of the secondary battery. In this test, the monomer was selected such that an amount of the monomer was one of 2 wt % to 15 wt % based on 100 wt % of a total weight of the first electrolyte and the second electrolyte. The monomer included a first monomer and a second monomer. A chemical formula of the first monomer is as shown in Chemical Formula 1 below, and a chemical formula of the second monomer is as shown in Chemical Formula 2 below.

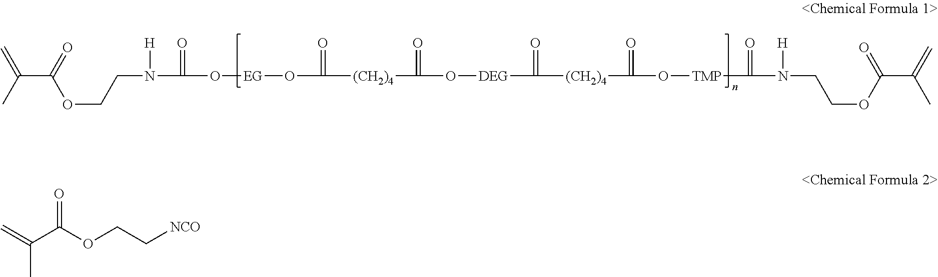

The first monomer is a urethane acrylate-based compound, and the second monomer is a hexyl acrylate-based compound. In the above chemical formulas, EG is ethylene glycol, DEG is diethylene glycol, and TMP is trimethylene propanol. As the polymerization initiator, 2,2′-azobis(dimethylvaleronitrile) having a product name V-65, which is an azo-based compound, was used. A chemical formula of the polymerization initiator is as shown in Chemical Formula 3 below.

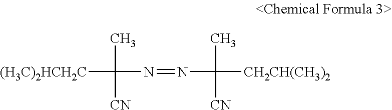

In the test example, the mixture including the monomer and the polymerization initiator was injected into the case of the secondary battery and then exposed to an atmosphere at a temperature of about 70° C. for about 1 to 3 hours. It was thereafter confirmed that the polymer gel was formed inside the case.

FIG. 11 is a cross-sectional view of the secondary battery 100 according to an embodiment of the present disclosure. In FIG. 11, the secondary battery 100 is explained in terms of its internal structure by approximately crossing the cutting line A of FIG. 2, while referencing another sectional view.

In an embodiment, the first electrode tab 112 and the first electrode terminal 122 of the secondary battery 100 may be electrically connected to each other. The second electrode tab 114 and the second electrode terminal 124 may be electrically connected to each other. For example, a first end of the first electrode tab 112 may be connected to one end of a first lead tab, and a second end of the first lead tab may be connected to the first electrode terminal 122 so that the first electrode tab 112 and the first electrode terminal 122 may be electrically connected to each other. Similarly, a first end of the second electrode tab 114 may be connected to one end of a second lead tab 1110, and a second end of the second lead tab 1110 may be connected to the second electrode terminal 124 so that the second electrode tab 114 and the second electrode terminal 124 may be electrically connected to each other.

An insulating member 1120 may be disposed in the void between the electrode assembly 110 and the case 140. For example, the insulating member 1120 may be disposed between one surface of the receiving portion 129 of the case 140 (e.g., a surface where the first electrode terminal 122 and/or the second electrode terminal 124 are formed) and the electrode assembly 110. The insulating member 1120 may also be disposed on one side of the electrode assembly 110 (e.g., a side where the first electrode tab 112 and/or the second electrode tab 114 are formed).

The insulating member 1120 may be plate shaped and be formed from an insulating material. For example, the insulating material may include PP (polypropylene), PE (polyethylene), PI (polyimide), PET (polyethylene Terephthalate), and the like. The insulating member 1120 may cover at least a portion of one surface of the case 140. The insulating member 1120 may cover at least a portion of one side of the electrode assembly 110.

The electrode tab (e.g., the first electrode tab 112 or the second electrode tab 114) and the lead tab (e.g., the first lead tab or the second lead tab 1110) may be bent inside the case 140 to be accommodated in the case 140. For example, the electrode tab 114 may be bent under the insulating member 1120 and connected to the lead tab 1110. The lead tab 1110 may be bent so as to surround the insulating member 1120.

The gel polymer 1130 may be formed inside the case 140. Specifically, the gel polymer 1130 may be formed by reaction between the monomer and the polymerization initiator injected into the interior of the case 140 at the predetermined temperature. For example, the gel polymer 1130 may include at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile). An amount of the gel polymer 1130 may be 2 wt % to 15 wt % based on 100 wt % of a total weight of the electrolyte.

The amount of the gel polymer 1130 located outside the electrode assembly 110 inside the case 140 may be greater than the amount of the gel polymer located inside the electrode assembly 110. Referring to FIG. 11, the amount of the gel polymer located in the external area EAO of the electrode assembly may be less than the amount of the gel polymer located in the internal area EAI of the electrode assembly. A portion of the electrolyte is first injected into the interior of the case 140, and at least a portion of the electrolyte may be impregnated into the electrode assembly 110. After the remaining portion of the electrolyte, the monomer, and the polymerization initiator are injected into the interior of the case 140 and the gel polymer 1130 is formed, the gel polymer 1130 may be formed at a relatively high amount outside the electrode assembly 110 rather than inside the electrode assembly 110.

In an embodiment, the gel polymer 1130 may buffer force applied to at least one of the electrode assembly 110 and the case 140. For example, an external force may be applied to the secondary battery 100 so that at least one of the electrode assembly 110 and the case 140 may receive an impact. Due to properties such as elasticity of the gel polymer 1130, the impact may be buffered.

As described above, since the gel polymer (1130) is relatively more located outside the electrode assembly (110) rather than inside the electrode assembly (110) within the case (140), it is possible to protect at least one of the electrode assembly (110) or the case (140). Additionally, since the gel polymer (1130) is located inside the electrode assembly (110) in a smaller amount, the movement of ions through the electrolyte may not be hindered, which ensures that the stability of the secondary battery (100) is improved while its performance remains unchanged.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE NUMERALS

100: secondary battery
110: electrode assembly
112: first electrode tab
114: second electrode tab
120: case body
122: first electrode terminal
124: second electrode terminal
126: electrolyte injection hole
128: flange
129: receiving portion
130: cover
140: case

What is claimed is:

1. A method of manufacturing a secondary battery comprising:
preparing a case in which an electrode assembly is accommodated;
injecting a first electrolyte into an interior of the case through an electrolyte injection hole formed in the case; and
injecting a solution into the interior of the case, after the first electrolyte has been injected, through the electrolyte injection hole of the case,
wherein the solution comprises a second electrolyte, a monomer, and a polymerization initiator.

2. The method of manufacturing a secondary battery as claimed in claim 1, further comprising, after injecting the first electrolyte, performing an aging process by allowing a predetermined time to elapse with the first electrolyte injected in the case.

3. The method of manufacturing a secondary battery as claimed in claim 2, further comprising, after performing the aging process, performing charging and discharging through electrode terminals that are provided on the case.

4. The method of manufacturing a secondary battery as claimed in claim 1, further comprising sealing the electrolyte injection hole of the case after the first electrolyte and the solution have been injected.

5. The method of manufacturing a secondary battery as claimed in claim 1, further comprising, after injecting the solution, exposing the case to a predetermined temperature so that the monomer and the polymerization initiator react with each other to form a gel polymer.

6. The method of manufacturing a secondary battery as claimed in claim 5, wherein the predetermined temperature is 40° C. to 80° C.

7. The method of manufacturing a secondary battery as claimed in claim 5, wherein the gel polymer comprises at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile).

8. The method of manufacturing a secondary battery as claimed in claim 1, wherein an amount of the first electrolyte is 40% to 70% based on 100% of a total volume or a total weight of the first electrolyte and the second electrolyte.

9. The method of manufacturing a secondary battery as claimed in claim 1, wherein an amount of the monomer is 2 wt % to 15 wt % based on 100 wt % of a total weight of the first electrolyte and the second electrolyte.

10. The method of manufacturing a secondary battery as claimed in claim 1, wherein an amount of the polymerization initiator is 150 ppm to 450 ppm based on 100 wt % of a total weight of the first electrolyte and the second electrolyte.

11. The method of manufacturing a secondary battery as claimed in claim 1, wherein the monomer comprises a functional monomer comprising at least one of urethane acrylate, hexyl acrylate, acrylate, acrylic acid, methacrylic acid, and a mixture including the acrylic acid and the methacrylic acid.

12. The method of manufacturing a secondary battery as claimed in claim 1, wherein the polymerization initiator comprises at least one of a peroxide-based compound and an azo-based compound.

13. A secondary battery comprising:
an electrode assembly;
an electrolyte at least partially impregnated in the electrode assembly;
a mixture of a monomer and a polymerization initiator; and
a case accommodating the electrode assembly, the electrolyte, and the mixture of the monomer and the polymerization initiator.

14. The secondary battery as claimed in claim 13, wherein an amount of the monomer is 2 wt % to 15 wt % based on 100 wt % of a total weight of the electrolyte.

15. The secondary battery as claimed in claim 13, wherein the monomer comprises a functional monomer including at least one of urethane acrylate, hexyl acrylate, acrylate, acrylic acid, methacrylic acid, and a mixture including the acrylic acid and the methacrylic acid.

16. The secondary battery as claimed in claim 13, wherein an amount of the polymerization initiator is 150 ppm to 450 ppm based on 100 wt % of a total weight of the electrolyte.

17. The secondary battery as claimed in claim 13, wherein the polymerization initiator comprises at least one of a peroxide-based compound and an azo-based compound.

18. A secondary battery comprising:
an electrode assembly;
an electrolyte at least partially impregnated in the electrode assembly;
a gel polymer; and
a case accommodating the electrode assembly, the electrolyte, and the gel polymer,
wherein at least a portion of the gel polymer is disposed in a void between the electrode assembly and the case.

19. The secondary battery as claimed in claim 18, wherein an amount of the gel polymer located outside the electrode assembly inside the case is greater than an amount of the gel polymer located inside the electrode assembly.

20. The secondary battery as claimed in claim 18, wherein the gel polymer comprises at least one of poly(urethane-acrylate), poly(ethylene-co-methyl acrylate), poly(ethylene-co-ethyl acrylate), poly(ethylene-co-butyl acrylate), poly(ethylene-co-acrylic acid), poly(ethylene-co-methacrylic acid), poly(ethylene-co-glycidyl methacrylate), poly(ethylene-co-maleic acid), poly(ethylene-co-vinyl acetate), poly(ethylene-co-acrylamide), and poly(ethylene-co-acrylonitrile).
